(19) United States
(12) Patent Application Publication
(10) Pub. No.: US 2021/0180455 A1
(43) Pub. Date: Jun. 17, 2021

(54) METHOD FOR TREATING A HIGH AND STEEP LANDSLIDE IN A MINE WITH A GENTLY-INCLINED AND WEAK INTERLAYER

(71) Applicant: Wuhan University of Science and Technology, Wuhan City (CN)

(72) Inventors: Bin HU, Wuhan City (CN); Jing LI, Wuhan City (CN); Jianlong SHENG, Wuhan City (CN); Zuyang YE, Wuhan City (CN); Shibing HUANG, Wuhan City (CN); Kai CUI, Wuhan City (CN); Guangquan ZHANG, Wuhan City (CN); Aneng CUI, Wuhan City (CN); Shuxiang CHANG, Wuhan City (CN)

(21) Appl. No.: 17/099,783

(22) Filed: Nov. 17, 2020

(30) Foreign Application Priority Data
Dec. 12, 2019 (CN) 201911273606.1

(51) Int. Cl. E21F 17/00; E02D 17/20

(52) U.S. Cl. CPC E21F 17/00; E02D 17/20

(57) ABSTRACT

The present disclosure provides a method for treating a high and steep landslide in a mine with a gently-inclined and weak interlayer. The method comprises the following steps as S1˜S4: S1. excavating small-benches on stable bedrock below a weak interlayer to form working surfaces for risk elimination process of landslide; S2. conducting the risk elimination process; S3. transporting a landslide accumulation body to a crushing station or a rock dump site; S4. repeating steps S1 to S3, and continuously advancing risk elimination along the working surfaces for the risk elimination process of landslide until treatment of the high and steep landslide in a mine with a gently-inclined and weak interlayer is completed. The method can treat the landslide from the root cause, avoiding a secondary landslide. The method does not affect structures and buildings in a mine, ensuring safety of personnel and excavator.

### CROSS-REFERENCE TO RELATED APPLICATIONS

This application claims the priority of Chinese Patent Application No. 201911273606.1, filed with China Patent Office on Dec. 12, 2019, which is incorporated herein by reference in its entirety.

### TECHNICAL FIELD

The present disclosure relates to the technical field of landslide treatment, and in particular to a method for treating a high and steep landslide in a mine with a gently-inclined and weak interlayer.

### BACKGROUND OF THE INVENTION

Landslides are one of main risks that affect safety and stability of slope projects in mines, hydropower, transportation, etc. Landslide treatment is to determine appropriate engineering technical measures according to geology terrain of a slope and working conditions, etc., so as to ensure a smooth progress of an on-site project and safety of personnel and apparatus. In southwest of China, such as Yunnan, Sichuan, Guizhou, Guangxi and other provinces, there is a wide range of gently-inclined and weak interlayers. Such weak interlayers are generally thin layers of shale containing carbon, silty sand, calcium and other mineral components, with a dip angle of less than 25°, low mechanical strength, poor water-physical properties and obvious rheological effects. Especially in rainy season, under softening effect of water, mechanical properties of the weak interlayers deteriorate, and ratio of anti-sliding force to sliding force decreases, so that a slope is in a critical instability state, and it is easy to cause large-scale sliding damage along the gently-inclined and weak interlayers. Due to existence of many structures and buildings in mines and uncertainty of landslide disasters, the landslides are prone to cause huge economic losses and endanger safety of personnel and apparatus. Therefore, treatment of a high and steep landslide in mines with gently-inclined and weak interlayers is very important.

Current technical solutions for landslide prevention mainly include interception drainage, slope cutting and unloading, anti-slide piles, and anti-slide retaining walls. Among them, the technical solutions of interception drainage, slope cutting and unloading can reduce sliding force of a sliding body and reduce landslide disaster, but these technical solutions cannot fundamentally realize landslide control. The technical solutions of anti-slide pile and anti-slide retaining wall can effectively control the landslide, but these technical solutions are prone to lead to material consumption and huge investment. Especially in treatment of landslide in mines, due to continuous excavation and advancement of slope in a mine, the technical solutions of anti-slide piles and anti-slide retaining walls gradually lose their roles in mining process.

For the landslide in mines along the gently-inclined and weak interlayer, if a traditional method is used to perform the landslide treatment directly on a landslide accumulation body from top to bottom, safety of personnel and apparatus is lower. Important structures and buildings behind the landslide, such as high-voltage towers, are on a sliding zone of the weak interlayer. In order to avoid disturbances in process of landslide treatment affecting stability of the important structures and buildings behind the landslide, blasting methods should be avoided in the landslide treatment. The roads up the hill behind the landslide and previous benches in a mine being destroyed, and working surface for the landslide treatment being damaged, lead to a smaller space for the landslide treatment. This type of landslides is controlled by the weak interlayer, so safety for the landslide treatment in a rainy season is poor. In view of complex geological conditions of mine engineering, high difficulty for the landslide treatment, large amount of the landslide treatment engineering and tight construction time, traditional treatment methods cannot fully meet requirement of the landslide treatment, and innovative treatment measures are required.

### SUMMARY OF THE INVENTION

The present disclosure is intended to overcome disadvantages in the prior art and provide a method for treating a high and steep landslide in a mine with a gently-inclined and weak interlayer. The method according to the present disclosure can treat a landslide from root cause and avoid a secondary landslide. Moreover, the method according to the present disclosure will not cause any impact on structures and buildings in a mine, and can guarantee safety of personnel and apparatus.

In order to achieve the above objects, the method for treating a high and steep landslide in a mine with a gently-inclined and weak interlayer according to the present disclosure may comprise: S1. excavating small-benches on stable bedrock below a weak interlayer to form working surfaces for risk elimination process of landslide; S2. conducting the risk elimination process, S3. transporting a landslide accumulation body to a crushing station or a rock dump site; and S4. repeating steps S1 to S3, and continuously advancing risk elimination along the working surfaces for the risk elimination process of landslide until treatment of the high and steep landslide in a mine with a gently-inclined and weak interlayer is completed, wherein the step S2 comprises the following steps: laying out the small-benches perpendicular to a stratus strike of a high slope in a mine with a gently-inclined and weak interlayer, and advancing risk elimination along the stratus strike; keeping a horizontal distance between the working surfaces for the risk elimination process implemented on adjacent small-benches equal to or greater than 50 m, and conducting the risk elimination process on two or more small-benches at the same time; a landslide accumulation body collapsing along a free surface side by its own weight; stable structure of a consolidated accumulation body being destroyed by vibrations of an excavator bucket, and then the consolidated accumulation body collapses by its own weight.

In some embodiments of the present disclosure, a slope gradient of the small-bench may be 5‰-7‰.

In some embodiments of the present disclosure, a height difference between two adjacent small-benches may be determined according to an operating range of excavator.

In some embodiments of the present disclosure, in the step S1, a crawler-type impact hammer may be used to excavate the small-benches on the stable bedrock below the weak interlayer.

Compared with the prior art, the method for treating a high and steep landslide in a mine with a gently-inclined and weak interlayer according to one or more embodiments of the present disclosure have at least the following technical effects and advantages:

According to one or more embodiments of the present disclosure, small-benches on stable bedrock below a weak interlayer are excavated to form working surfaces for risk elimination process of landslide, and the steps of conducting the risk elimination process as described in step S2 of the present disclosure are performed, then a landslide accumulation body is cleaned up. Wherein, the small-benches are arranged on stable bedrock below the weak interlayer, thereby improving safety of a landslide treatment. In addition, the small-benches can not only be used as a platform for the landslide treatment, but also as a small safety platform for a slope in a mine after the landslide treatment is completed, to buffer and block falling rocks. Furthermore, the technical solution of “conducting risk elimination process on two or more small-benches at the same time” greatly speeds up progress of risk elimination. The technical solution of “keeping a horizontal distance between the working surfaces for the risk elimination processes implemented on adjacent small-benches equal to or greater than 50 m” ensures safety of the risk elimination, and avoids damages to personnel or apparatus on a lower working surface for the risk elimination process during the progress of a upper working surface for the risk elimination process. The technical solution of “stable structure of a consolidated accumulation body being destroyed by vibrations of an excavator bucket, and then the consolidated accumulation body collapses by its own weight” does not adopt any blasting process, which can avoid impact of blasting vibrations on a landslide accumulation body, eliminating a secondary landslide and having no impact on structures and buildings in a mine, and thus safety of the landslide treatment is guaranteed. A crawler-type impact hammer is used to excavate the small-benches on the bedrock below the weak interlayer, which can avoid use of blasting process, and thus avoiding adverse influences on the landslide due to blasting vibrations. In addition, a slope gradient of the small-bench can be 5‰˜7‰, which facilitates drainage of accumulated water during the landslide treatment.

### BRIEF DESCRIPTION OF THE DRAWINGS

FIG. 1 is a construction flow chart of a landslide treatment according to one or more embodiments of the present disclosure.

FIG. 2 is a schematic sectional view of the landslide treatment according to one or more embodiments of the present disclosure.

FIG. 3 is a schematic sectional view of small-benches according to one or more embodiments of the present disclosure.

FIG. 4 is a schematic plan view of the small-benches according to one or more embodiments of the present disclosure.

FIG. 5 is a schematic diagram showing an operating range of an excavator according to one or more embodiments of the present disclosure.

FIG. 6 is a schematic diagram showing cleaning and advancing of a landslide accumulation body according to one or more embodiments of the present disclosure.

FIG. 7 is a schematic diagram showing a technical solution of “a landslide accumulation body collapsing along a free surface side by its own weight; stable structure of a consolidated accumulation body being destroyed by vibrations of an excavator bucket, and then the consolidated accumulation body collapses by its own weight” according to one or more embodiments of the present disclosure.

### REFERENCE NUMERALS IN THE FIGURES ARE LISTED AS BELOW

1. High slope in a mine with a gently-inclined and weak interlayer; 2. small-bench; 3. excavator; 4. mine truck; 5. landslide accumulation body; 6. weak interlayer; 7. operating range; a. width of small-bench; α. slope inclination; h. height difference between two adjacent small-benches; A. natural angle of repose; L. horizontal distance between the working surfaces for the risk elimination process implemented on adjacent small-benches.

### DETAILED DESCRIPTION OF THE INVENTION

The present disclosure will be further described below with reference to drawings and embodiments.

One or more embodiments of the present disclosure provide a method for treating a high and steep landslide in a mine with a gently-inclined and weak interlayer, comprising the following steps S1˜S4:

S1. excavating small-benches on stable bedrock below a weak interlayer to form working surfaces for risk elimination process of landslide;

S2. conducting the risk elimination process;

S3. transporting a landslide accumulation body to a crushing station or a rock dump site; and

S4. repeating steps S1 to S3, and continuously advancing risk elimination along the working surfaces for the risk elimination process of landslide until treatment of the high and steep landslide in a mine with a gently-inclined and weak interlayer is completed; and wherein:

the step S2 comprises the following steps: laying out the small-benches perpendicular to a stratus strike of a high slope in a mine with a gently-inclined and weak interlayer, and advancing risk elimination along the stratus strike; keeping a horizontal distance between the working surfaces for the risk elimination processes implemented on adjacent small-benches equal to or greater than 50 m, and conducting the risk elimination process on two or more small-benches at the same time; a landslide accumulation body collapsing along a free surface side by its own weight; stable structure of a consolidated accumulation body being destroyed by vibrations of an excavator bucket, and then the consolidated accumulation body collapses by its own weight.

In some embodiments of the present disclosure, a slope gradient of the small-bench is 5‰-7‰.

In some embodiments of the present disclosure, a height difference between two adjacent small-benches is determined according to an operating range of excavator.

In some embodiments of the present disclosure, in the step S1, a crawler-type impact hammer is used to excavate the small-benches on the stable bedrock below the weak interlayer.

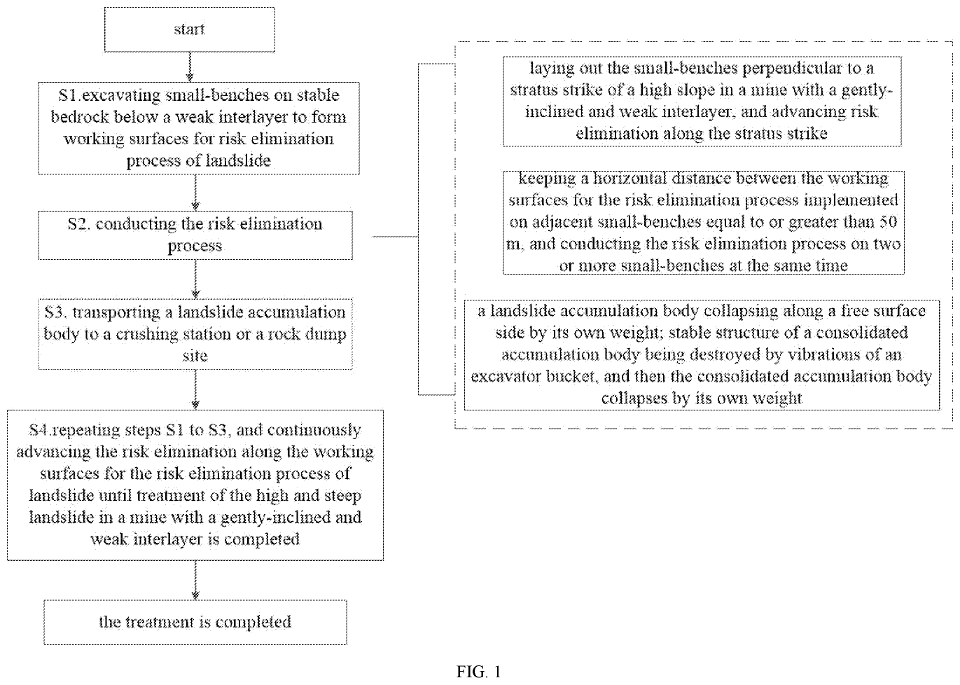

As shown in FIG. 1, the method for treating a high and steep landslide in a mine with a gently-inclined and weak interlayer according to one or more embodiments of the present disclosure comprises the following steps S1˜S4.

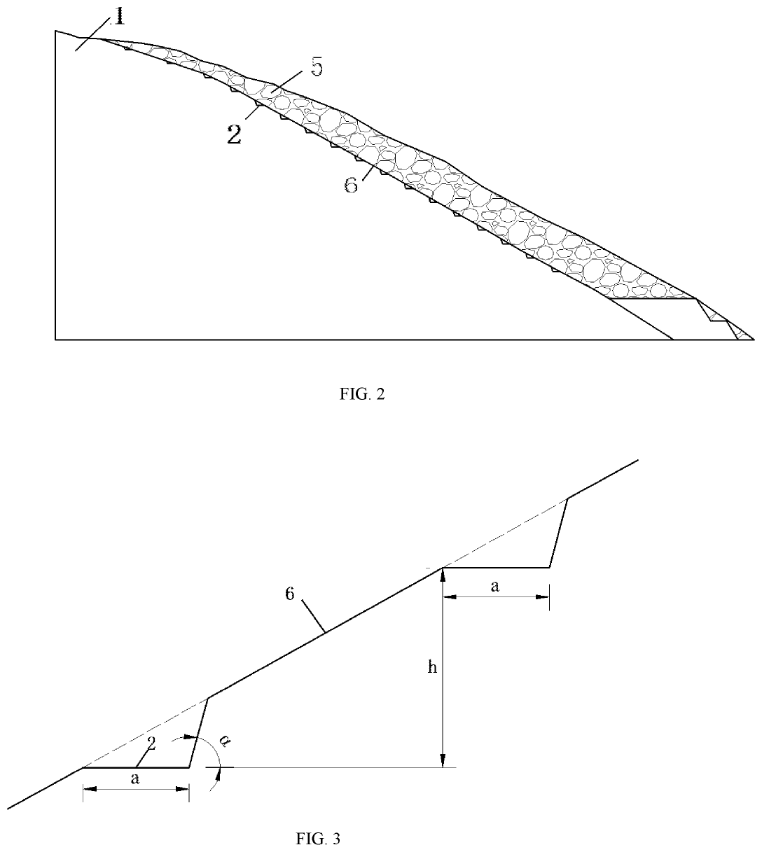

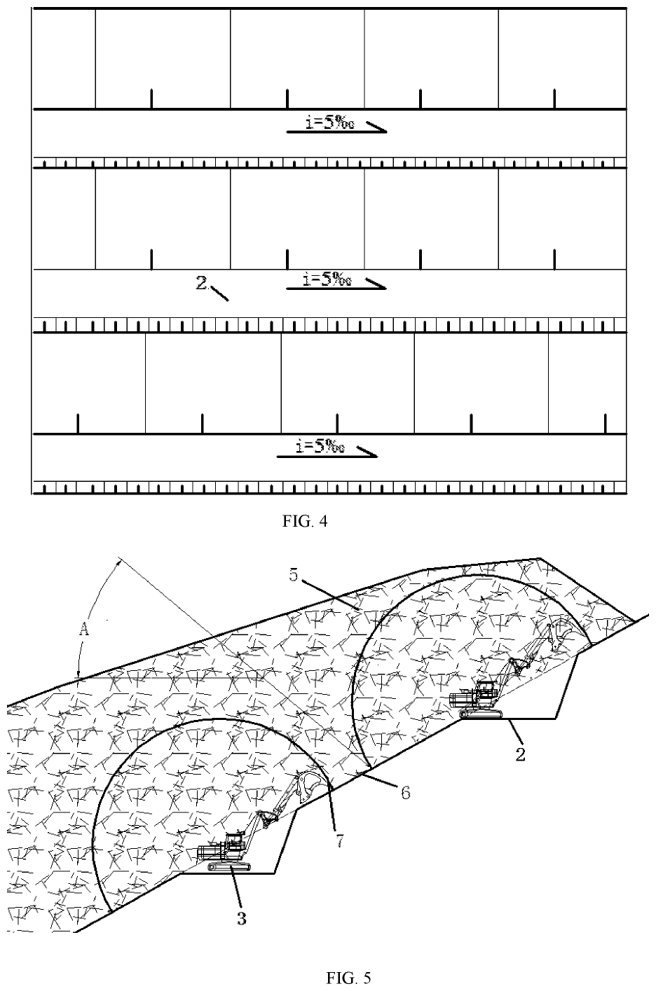

As for step S1, as shown in FIG. 2, on a high slope 1 in a mine with a gently-inclined and weak interlayer, a crawler-type impact hammer is used to excavate small-benches 2 on stable bedrock below a weak interlayer 6, so as to form working surfaces for risk elimination processes of landslide.

As for step S2, the risk elimination process is conducted.

As for step S3, a landslide accumulation body 5 is transported to a crushing station or a rock dump site; specifically, the excavator 3 is used to clean up the landslide accumulation body 5, and a mine truck 4 is used to transport the landslide accumulation body 5 to a crushing station or a rock dump site.

As for step S4, the steps S1 to S3 are repeated, and the risk elimination along the working surface for the risk elimination process of landslide is continuously advanced until treatment of the high and steep landslide in a mine with a gently-inclined and weak interlayer is completed.

The step S2 may further comprise the following steps S2.1˜S2.3:

As for step S2.1, the small-benches 2 are laid out perpendicular to a stratus strike of a high slope 1 in a mine with a gently-inclined and weak interlayer, and risk elimination along the stratus strike is advanced. In one or more embodiments, slope inclination a of the small-bench 2 is 75°, as shown in FIG. 3. A width a of the small-benches is 4 m. In order to ensure a speed of landslide treatment, the width of the small-bench should not be too wide, as long as it can meet operating requirement of the excavator 3. In order to facilitate drainage of accumulated water during the landslide treatment, a slope gradient of the small-bench is set to be 5‰.

As for step S2.2, the excavator 3 is used to advance the risk elimination, and a horizontal distance L between the working surfaces for the risk elimination processes implemented on adjacent small-benches is kept to be equal to or greater than 50 m. On premise of safe risk elimination processes, the risk elimination processes on two or more small-benches 2 are conducted at the same time. As shown in FIG. 3, a height difference h between two adjacent small-benches is set to be 7.5 m to meet an operating range 7 of the excavator 3. The operating range 7 of the excavator 3 is shown in FIG. 5.

As for step S2.3, a landslide accumulation body 5 collapses along a free surface side by its own weight to avoid influence of blasting on stability of the landslide accumulation body 5. Stable structure of a consolidated accumulation body is destroyed by vibrations of a bucket of the excavator, and then the consolidated accumulation body collapses by its own weight.

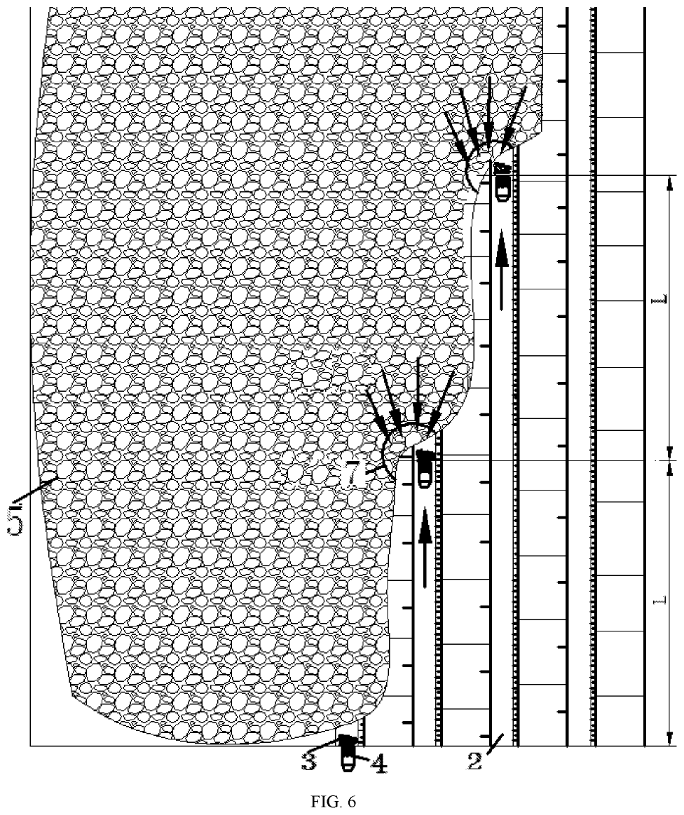

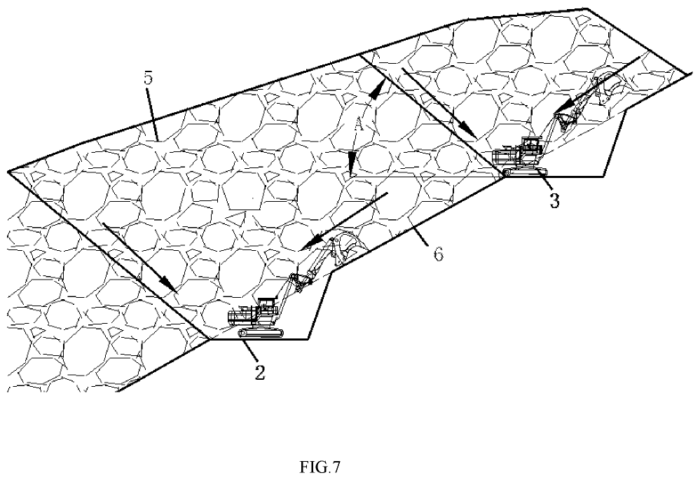

In one or more embodiments, the landslide treatment is carried out from top to bottom. As shown in FIG. 6, the working surface for risk elimination process should be promoted from top small-benches. An advancing distance of the working surface for risk elimination process is set in strict accordance with requirements of specification. After the advancing distance of the working surface for risk elimination process of a first row of the small-benches is equal to or greater than 50 meters, the working surface for risk elimination process of next row of the small-benches starts to work, and so on. After the advancing distance of the working surface for risk elimination process of a second row of the small-benches is kept to be equal to or greater than 50 meters, the working surface for the risk elimination process of a third row of the small-benches starts to work, and so on. As shown in FIG. 7, the landslide accumulation body 5 collapses in a direction as shown by the arrows in FIG. 7. The landslide accumulation body 5 collapses down by its own weight along a slope of the weak interlayer and a direction of natural angle of repose A of about 40°, and then the mine truck 4 is used to transport away collapsed landslide accumulation body 5.

The above-mentioned specific embodiments are merely explanations of the present disclosure, not a limitation of the invention. Any modifications, equivalent replacements, improvements, etc. made within the spirit and principle of the present disclosure shall be included in the protection scope of the present disclosure.

The technical scheme according to one or more embodiments of the present disclosure can completely remove the landslide accumulation body, treat the landslide from the root cause, and avoid possibility of a secondary landslide. The technical scheme according to one or more embodiments of the present disclosure has high feasibility, and apparatus involved for the landslide treatment is common mine apparatus, which can quickly and efficiently treat the landslide, and effectively reduce cost of the landslide treatment.

1. A method for treating a high and steep landslide in a mine with a gently-inclined and weak interlayer, comprising:
S1. excavating small-benches on stable bedrock below a weak interlayer to form working surfaces for risk elimination process of landslide;
S2. conducting the risk elimination process;
S3. transporting a landslide accumulation body to a crushing station or a rock dump site; and
S4. repeating steps S1 to S3, and continuously advancing risk elimination along the working surfaces for the risk elimination process of landslide until treatment of the high and steep landslide in a mine with a gently-inclined and weak interlayer is completed;
wherein, the step S2 further comprises the following steps:
laying out the small-benches perpendicular to a stratus strike of a high slope in a mine with a gently-inclined and weak interlayer, and advancing risk elimination along the stratus strike;
keeping a horizontal distance between the working surfaces for the risk elimination process implemented on adjacent small-benches equal to or greater than 50 m, and conducting the risk elimination process on two or more small-benches at the same time;
a landslide accumulation body collapsing along a free surface side by its own weight; and
stable structure of a consolidated accumulation body being destroyed by vibrations of an excavator bucket, and then the consolidated accumulation body collapses by its own weight.

2. The method for treating a high and steep landslide in a mine with a gently-inclined and weak interlayer according to claim 1, wherein a slope gradient of the small-bench is 5‰-7‰.

3. The method for treating a high and steep landslide in a mine with a gently-inclined and weak interlayer according to claim 1, wherein a height difference between two adjacent small-benches is determined according to an operating range of excavator.

4. The method for treating a high and steep landslide in a mine with a gently-inclined and weak interlayer according to claim 1, wherein in the step S1, a crawler-type impact hammer is used to excavate the small-benches on the stable bedrock below the weak interlayer.
